(19) United States
(12) Patent Application Publication
(10) Pub. No.: US 2024/0317915 A1
(43) Pub. Date: Sep. 26, 2024

(54) COPOLYMER COMPOSITION AND ORGANIC-INORGANIC COMPOSITE FILM WITH ADJUSTABLE REFRACTIVE INDEX PREPARED FROM COPOLYMER-TITANIUM COMPOSITE COMPOSITION

(71) Applicant: KOREA RESEARCH INSTITUTE OF CHEMICAL TECHNOLOGY, Daejeon (KR)

(72) Inventors: Jong Mok PARK, Daejeon (KR); Tae Gyu HWANG, Daejeon (KR); Seo Hyun JUNG, Daejeon (KR); Hoyoul KONG, Jinju (KR); Yu Jin JUNG, Daejeon (KR); Bogyu LIM, Daejeon (KR); Min Ju JEONG, Daejeon (KR)

(73) Assignee: KOREA RESEARCH INSTITUTE OF CHEMICAL TECHNOLOGY, Daejeon (KR)

(21) Appl. No.: 18/579,008

(22) PCT Filed: Oct. 19, 2022
(86) PCT No.: PCT/KR2022/015969

§ 371 Date: Jan. 12, 2024

(30) Foreign Application Priority Data
Oct. 19, 2021 (KR) 10-2021-0138931
Oct. 18, 2022 (KR) 10-2022-0134124

(51) Int. Cl. C08F 220/58; C08F 8/42; C08F 220/30; C08J 5/18

(52) U.S. Cl. CPC C08F 220/58; C08F 8/42; C08F 220/30; C08J 5/18; C08J 2333/14; C08J 2333/24

(57) ABSTRACT

Provided are a copolymer-titanium composite which is crosslinked without a crosslinking agent and an initiator and a copolymer-titanium composite composition including the composite. An organic-inorganic hybrid film produced by including the composition may have a significant refractive index without a large increase in a thickness change rate and may solve a problem of a decrease in optical properties by low dispersibility of a conventional organic-inorganic film by a chemically bonded oxygen-titanium network structure, and an organic film having an excellent refractive index may be provided only with the copolymer.

### CROSS REFERENCE TO RELATED APPLICATIONS

This application is a National Stage of International Application No. PCT/KR2022/015969 filed Oct. 19, 2022, claiming priorities based on Korean Patent Application No. 10-2021-0138931 filed Oct. 19, 2021 and on Korean Patent Application No. 10-2022-0134124 filed Oct. 18, 2022.

### TECHNICAL FIELD

The present invention relates to a copolymer composition, a copolymer-titanium composite composition, and films produced therefrom.

### BACKGROUND ART

Material development is in progress in light emitting diodes (LED), lenses, or displays requiring a refractive index.

As refractive index materials which are used a lot from the past to the present, inorganic refractive index materials produced by including inorganic compounds such as nano-zinc, nano-titanium, or nano-zirconium are used a lot. However, the inorganic refractive index material does not have excellent impact resistance, and not only has a demerit of being easily broken even with a small impact but also, when being produced into a coating film or a film, has a large thickness and increased mass, and thus, it is difficult to apply the material to the field of using a high refractive index which is currently changing to being lightweight.

Therefore, in order to solve the problems of high mass and a large thickness of the inorganic refractive index materials, polymer-based refractive index materials produced by using polymers are used a lot, and the polymer used as the refractive index materials includes polycarbonate (PC) including a benzene ring, polyethylene terephthalate (PET), or the like.

However, the conventional polymer-based refractive index materials are bound to have a lower optical effect such as a refractive index and a scattering rate of light than inorganic refractive index materials. That is, the polymer-based refractive index materials have a limited maximum refractive index and it is not easy to obtain a high refractive index only with the molecular design of the polymer-based materials.

In order to compensate for each of the demerits of the conventional inorganic refractive index materials and polymer-based refractive index materials, it was intended to mix a particulate-type inorganic compound with the polymer to produce an organic-inorganic refractive index material, but dispersion was not performed so that small particles at a single nano level did not aggregate for obtaining a transparent material in a visible light wavelength region, and thus, transparency was bound to decline.

That is, in order to mix the polymer-based material and the inorganic material, inorganic materials should be dispersed with a high dispersion degree in a polymer resin, as described above, and the refractive index of the polymer-based optical materials may be improved by increasing a content of the inorganic materials, but the method of increasing the refractive index by increasing the content of the inorganic particles in the polymer-based resin causes demerits such as a decreased dispersion degree and opacity, and thus, there is a great difficulty in commercial application.

In addition, the conventional organic-inorganic refractive index materials in which inorganic particles are mixed with a polymer should have a refractive index suited to the use field, but since the process of processing the film thickness consistently is difficult due to the problems of the low refractive index of the polymer and the high mass and large thickness of the inorganic matter and the problem of low dispersibility of the conventional organic-inorganic refractive index materials, a manufacturing process and application are limited.

Therefore, a new organic-inorganic refractive index material which may have an excellent refractive index, has an easily adjustable thickness, and allows an inorganic matter to be applied without a problem of low dispersibility is needed.

### DISCLOSURE

### Technical Problem

An object of the present invention is to provide an organic-inorganic hybrid film which is produced by including a copolymer-titanium composite composition and has easily adjustable thickness and refractive index.

Another object of the present invention is to provide a copolymer which reacts with a titanium-alkoxide to produce the copolymer-titanium composite with high dispersibility, and also an organic film having an excellent refractive index.

Another object of the present invention is to provide a copolymer-titanium composite and a copolymer which are crosslinkable without adding a photoinitiator and a crosslinking agent.

Still another object of the present invention is to provide a copolymer-titanium composite composition which may be produced only by a simple process and an organic-inorganic hybrid film produced by including the composition.

### Technical Solution

In one general aspect, a copolymer-titanium composite includes: repeating units represented by the following Chemical Formulae 1 and 2:

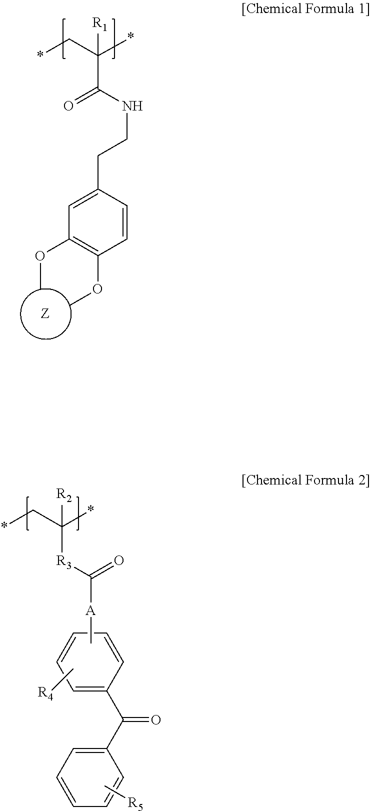

wherein R₁, R₂, R₄, and R₅ are independently of one another hydrogen, a halogen, or a C₁ to C₄ alkyl group, R₃ is a single bond or C₁ to C₃ alkylene, A is —O— or —NH—, and Z is an oxygen-titanium network structure.
As an exemplary embodiment, in Chemical Formulae 1 and 2, R₁ and R₂ may be independently of each other hydrogen or C₁ to C₃ alkyl, R₄ and R₅ may be independently of each other hydrogen or a halogen, R₃ may be a single bond or methylene, A may be —O— or —NH—, and Z may be an oxygen-titanium network structure.

As an exemplary embodiment, the copolymer-titanium composite may have a mole ratio between Chemical Formula 1 and Chemical Formula 2 may be 95:5 to 80:20.

As an exemplary embodiment, the copolymer-titanium composite may further include a repeating unit represented by the following Chemical Formula 3:

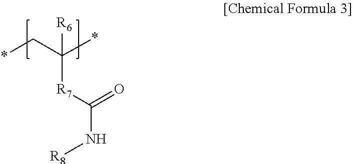

wherein R₆ is hydrogen, a halogen, or C₁ to C₄ alkyl, R₇ is a single bond or C₁ to C₃ alkylene, and R₈ is C₁ to C₁₀ alkyl or a halogen.

As an exemplary embodiment, in Chemical Formula 3, R₆ may be independently of each other hydrogen or methyl, R₇ may be a single bond or methylene, and R₈ may be C₂ to C₈ alkyl.

As an exemplary embodiment, the copolymer-titanium composite may have a mole fraction of Chemical Formulae 1 to 3 of m, n, and 1, in which m, n, and l are rational numbers satisfying 0.08≤m≤0.15, 0.02$n$0.05, 0.8$1$0.9, and m+n+1=1.

In another general aspect, a copolymer-titanium composite composition includes the copolymer-titanium composite.

In another general aspect, a method of producing a copolymer-titanium composite composition includes: adding a copolymer including repeating units of Chemical Formulae 4 and 5 to a solvent including an acid catalyst to produce a copolymer solution and adding a titanium-alkoxide to the copolymer solution to produce a copolymer-titanium composite composition:

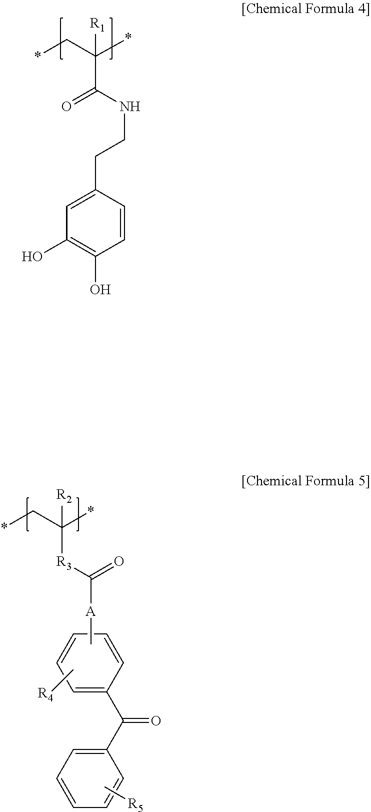

wherein R₁, R₂, R₄, and R₅ are independently of one another hydrogen, a halogen, or a C₁ to C4 alkyl group, R₃ is a single bond or C₁ to C₃ alkylene, and A is —O— or —NH—.

As an exemplary embodiment, the copolymer may further include a repeating unit represented by the following Chemical Formula 6:

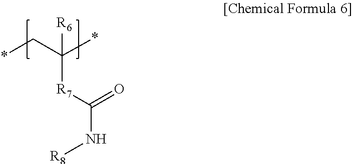

wherein R₆ is hydrogen, a halogen, or C₁ to C₄ alkyl, R₇ is a single bond or C₁ to C₆ alkylene, and R₈ is C₁ to C₁₀ alkyl or a halogen.

As an exemplary embodiment, the solvent may be any one or two or more selected from ether-based solvents, ketone-based solvents, amide-based solvents, alcohol-based solvents, sulfone-based solvents, and aromatic hydrocarbon-based solvents.

As an exemplary embodiment, the copolymer and the titanium-alkoxide may be added at a mass ratio of 1:99 to 99:1.

As an exemplary embodiment, the titanium-alkoxide may be Ti(OR)₄, wherein R may be C₁ to C₈ alkyl.

In another general aspect, an organic-inorganic hybrid film which is produced from the copolymer-titanium composite composition and has a refractive index of 1 to 3 is provided.

In another general aspect, a copolymer includes: repeating units represented by the following Chemical Formulae 4 and 5:

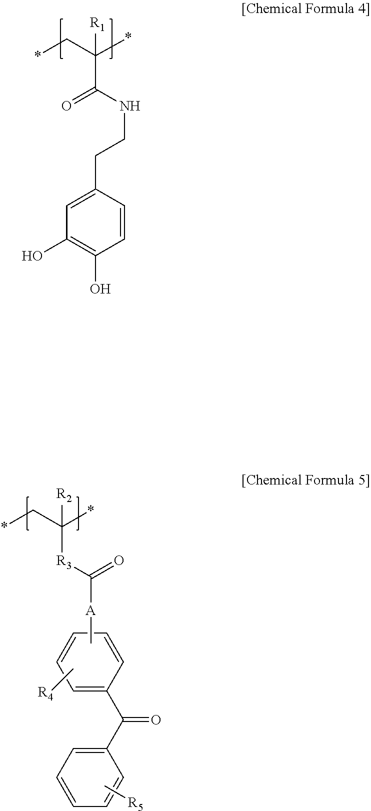

wherein R₁, R₂, R₄, and R₅ are independently of one another hydrogen, a halogen, or C₁ to C₄ alkyl, R₃ is a single bond or C₁ to C₃ alkylene, and A is —O— or —NH—.

As an exemplary embodiment, the copolymer may further include a repeating unit represented by the following Chemical Formula 6:

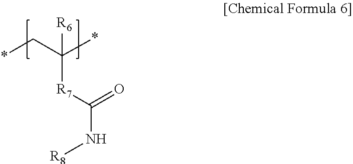

wherein R₆ is hydrogen, a halogen, or C₁ to C₄ alkyl, R₇ is a single bond or C₁ to C₆ alkylene, and R₈ is C₁ to C₁₀ alkyl or a halogen.

In still another general aspect, a copolymer composition includes: the copolymer and a solvent.

### Advantageous Effects

The copolymer-titanium composite composition according to an exemplary embodiment of the present invention has an adjusted titanium-alkoxide content, and the organic-inorganic hybrid film produced by including the composition has a refractive index which is more easily adjustable and may be thinner than a film of an inorganic material.

Therefore, the organic-inorganic hybrid film produced from the copolymer-titanium composite composition of the present invention has a thickness and a refractive index which are more significantly easily adjustable than a film of a conventional inorganic material, may have significant impact strength, chemical resistance, and an excellent refractive index compared to thickness, and may solve a problem of low dispersibility of inorganic particles included in the conventional organic-inorganic refractive index materials.

### BEST MODE

Hereinafter, a copolymer-titanium composite composition and an organic-inorganic hybrid film produced by including the composition according to the present invention will be described in detail. Here, technical terms and scientific terms used in the present specification have the general meanings understood by those skilled in the art to which the present invention pertains unless otherwise defined, and description for the known function and configuration which may unnecessarily obscure the gist of the present invention will be omitted in the following description.

The singular form used in the present specification may be intended to also include a plural form, unless otherwise indicated in the context.

In addition, the numerical range used in the present specification includes all values within the range including the lower limit and the upper limit, increments logically derived in a form and span of a defined range, all double limited values, and all possible combinations of the upper limit and the lower limit in the numerical range defined in different forms. Unless otherwise defined in the specification of the present invention, values which may be outside a numerical range due to experimental error or rounding off of a value are also included in the defined numerical range.

A “film” in the present specification is a term including a coating film and a thin film on a substrate.

The term “single bond” in the present specification refers to a direct connection.

The term “alkyl” in the present specification may be a term including both linear (straight chain) and branched alkyls and having 1 to 10 carbon atoms.

The term “alkylene” in the present specification may be a term referring to a divalent organic radical derived by removing one hydrogen.

The term “halogen” in the present specification may be a term referring to fluoro (F), chloro (Cl), bromo (Br), iodine radical, or the like.

Hereinafter, a copolymer-titanium composite and a film produced therefrom of the present invention will be described in detail.

The present invention provides a copolymer including: repeating units represented by the following Chemical Formulae 4 and 5:

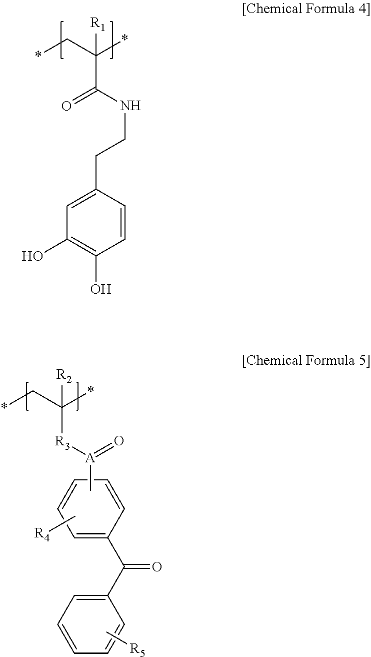

wherein
R₁, R₂, R₄, and R₅ are independently of one another hydrogen, a halogen, or a C₁ to C₄ alkyl group, R₃ is a single bond or C₁ to C₃ alkylene, and A is —O— or —NH—.

Specifically, in Chemical Formulae 4 and 5, R₁ and R₂ may be independently of each other hydrogen or C₁ to C₃ alkyl, R₄ and R₅ may be independently of each other hydrogen or a halogen, R₃ may be a single bond or methylene, and A may be —O— or —NH—.

The copolymer including the repeating unit represented by Chemical Formula 4 forms a radical at a wavelength of 350 to 400 nm, whereby a copolymer composition including the copolymer is crosslinkable without adding a photoinitiator or a crosslinking agent.

In addition, a copolymer-titanium composite produced by including the copolymer described later is also crosslinkable without adding a photoinitiator or a crosslinking agent.

The copolymer according to an exemplary embodiment may be a copolymer further including a repeating unit represented by the following Chemical Formula 6:

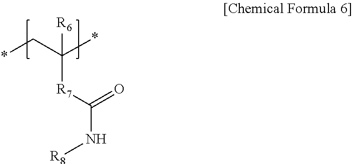

wherein R₆ is hydrogen, a halogen, or C₁ to C₄ alkyl, R₇ is a single bond or C₁ to C₆ alkylene, and R₈ is C₁ to C₁₀ alkyl or a halogen.

The copolymer further including the repeating unit represented by Chemical Formula 6 has not only excellent flexibility but also excellent hydrophilicity and biocompatibility, thereby producing a hydrogel-type organic film such as a contact lens, which may be thus preferred.

In addition, the present invention provides a copolymer composition including the copolymer and a solvent.

The solvent may be, as an example, one or two or more selected from ether-based solvents, ketone-based solvents, amide-based solvents, alcohol-based solvents, sulfone-based solvents, and aromatic hydrocarbon-based solvents, and more specifically, may be an alcohol-based solvent or a ketone-based solvent, but is not limited thereto.

In an exemplary embodiment of the present invention, the organic film produced by the copolymer composition may have a refractive index of 1.30 or more, specifically in a range of 1.4 to 1.8 as measured by the measurement method defined in the present invention, and may not be produced with the copolymer-titanium composite described later, and thus, may be used alone as a polymer-based refractive film having the refractive index in the above range.

Hereinafter, the copolymer-titanium composite produced by including the copolymer and a titanium-alkoxide will be described in more detail.

A copolymer-titanium composite in which an oxygen-titanium network structure is introduced to the copolymer may be provided.

The copolymer-titanium composite may have an adjustable refractive index while having a small thickness change rate, and may have a structure combined with the oxygen-titanium network structure, thereby having flexibility and impact strength without impairing transparency.

In an exemplary embodiment, the copolymer-titanium composite includes repeating units represented by the following Chemical formulae 1 and 2:

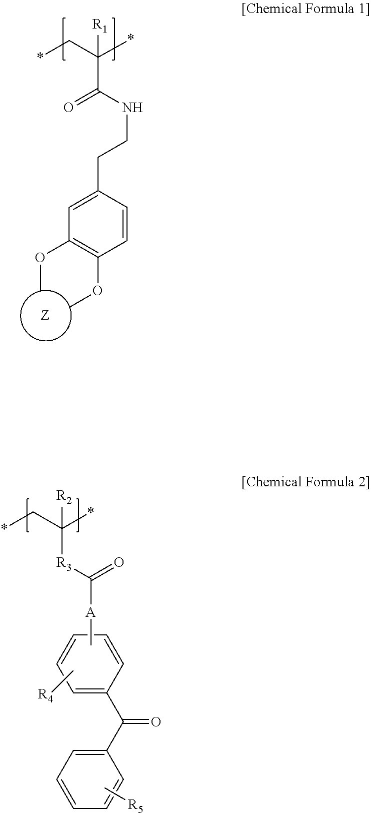

wherein R₁, R₂, R₄, and R₅ are independently of one another hydrogen, a halogen, or a C₁ to C₄ alkyl group, R₃ is a single bond or C₁ to C₃ alkylene, A is —O— or —NH—, and Z is an oxygen-titanium network structure.

Specifically, in Chemical formulae 1 and 2, R₁ and R₂ may be independently of each other hydrogen or C₁ to C₃ alkyl, R₄ and R₅ may be independently of each other hydrogen or a halogen, R₃ may be a single bond or methylene, and A may be —O— or —NH—.

Specifically, in Chemical Formula 1, Z is an oxygen-titanium network structure including a bond in the form of (—Ti—O—Ti—)ₙ, the oxygen-titanium network structure may include-Ti—OH or HO—Ti—, and more specifically, n in the bond in the form of (—Ti—O—Ti—)ₙ may vary depending on the amount of titanium-alkoxide added.

The copolymer-titanium composite includes Z in Chemical Formula 1, thereby solving a problem of significantly low dispersibility of a conventional organic-inorganic composite produced by blending inorganic particles and a polymer resin and also adjusting refractive indexes without a large thickness rate change depending on a titanium-alkoxide content.

In an exemplary embodiment of the present invention, in the copolymer-titanium composite, a mole ratio between Chemical Formula 1 and Chemical Formula 2 may be 95:5 to 80:20, specifically 90:10 to 80:20.

The copolymer-titanium composite including the repeating units at the mole ratio in the above range is preferred since it has an excellent refractive index and also a film produced therefrom has an excellent gelation rate.

The copolymer-titanium composite according to an exemplary embodiment of the present invention may further include a repeating unit represented by the following Chemical Formula 3:

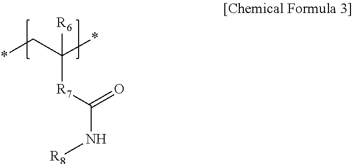

wherein
R₆ is hydrogen, a halogen, or C₁ to C₄ alkyl, R₇ is a single bond or C₁ to C₃ alkylene, and R₈ is C₁ to C₁₀ alkyl or a halogen.

Specifically, in Chemical Formula 3, R₆ may be hydrogen or CH₃, R₇ may be a single bond or methylene, and R₈ may be C₂ to C₈ alkyl, and more specifically, R₈ may be C₂ to C₅ alkyl.

In the copolymer-titanium composite according to an exemplary embodiment of the present invention, each mole fraction of Chemical Formulae 1 to 3 is m, n, and 1, wherein m, n, and 1 are rational numbers satisfying m+n+1=1, 0.08≤m≤0.15, 0.02≤n≤0.05, and 0.8≤130.9, and specifically, rational numbers satisfying 0.08≤m≤0.15, 0.08≤m≤0.15, and 0.85≤1≤0.95, but the physical properties of the copolymer-titanium composite may be impaired.

The copolymer-titanium composite having the mole fraction in the above range may have better refractive index and biocompatibility than the copolymer-titanium composite including only the repeating units represented by Chemical Formulae 1 and 2, and the organic-inorganic hybrid film produced by including the composite may have a gelation rate 19/36 Substitute Specification-Clean at a commercially acceptable level, and thus, have better chemical resistance.

The present invention provides a copolymer-titanium composite composition including the copolymer-titanium composite.

As an exemplary embodiment, the copolymer-titanium composite composition includes a solvent.

The solvent according to an exemplary embodiment of the present invention may be any one or two or more selected from ether-based solvents, ketone-based solvents, amide-based solvents, alcohol-based solvents, sulfone-based solvents, and aromatic hydrocarbon-based solvents, and specifically, may be an alcohol-based solvent or a ketone-based solvent, or a mixture thereof, but is not limited as long as it may dissolve the copolymer.

The solvent included in the copolymer-titanium composite composition may be the same as or different from the solvent included in a method of producing a copolymer-titanium composite composition described later, and if different, it may refer to a solvent dissolving a copolymer-titanium composite in a solid form, and may be a solvent which is further added to the copolymer-titanium composite composition produced.

The copolymer-titanium composite composition according to an exemplary embodiment may include 10 to 50 wt %, specifically 15 to 40 wt %, and more specifically 15 to 30 wt % of the copolymer-titanium composite.

The copolymer-titanium composite composition including the copolymer-titanium composite at the content in the above range may provide viscosity with excellent workability, but the viscosity is adjustable depending on a coating process method and the present invention is not limited thereto.

Hereinafter, a method of producing the copolymer-titanium composite composition will be described in more detail.

The method of producing a copolymer-titanium composite composition of the present invention includes: producing a copolymer solution in which the copolymer is added to a solvent including an acid catalyst and adding a titanium-alkoxide to the copolymer solution to produce a copolymer-titanium composite composition.

The acid catalyst usable herein is not limited as long as it is commonly used, and specifically, may be hydrochloric acid and the like.

The solvent included in the copolymer solution may be any one or two or more selected from ether-based solvents, ketone-based solvents, amide-based solvents, alcohol-based solvents, sulfone-based solvents, and aromatic hydrocarbon-based solvents, and specifically, may be an alcohol-based solvent or a ketone-based solvent, or may be a mixture thereof.

As another exemplary embodiment, the solvent included in the copolymer may be the same as or different from that of the copolymer composition, but is not limited as long as it may dissolve the copolymer.

The polymer solution is a solution in which a solid content of copolymer is dissolved in a solvent and may be different from the polymer composition, and specifically, the polymer composition is for producing an organic film, and the polymer solution may be for providing a viscosity at which the copolymer-titanium composite composition produced with the titanium-alkoxide with excellent reactivity is usable.

The copolymer solution may include 0.05 to 0.5 g of a copolymer based on 5 ml of a solvent, and specifically, may include 0.1 to 0.3 g for having significant reactivity with a titanium-alkoxide, but is not limited as long as it does not impair the physical properties of the produced copolymer-titanium composite.

As an exemplary embodiment, the method of producing a copolymer-titanium composite composition may further include producing a copolymer.

The producing of a copolymer may be a commonly commercially available polymerization method and may be bulk polymerization, suspension polymerization, emulsion polymerization, or the like, but is not limited as long as it is a polymerization method of producing a copolymer.

As an exemplary embodiment, the producing of a copolymer may be performed by a radical polymerization method including an initiator.

The initiator may be used without limitation as long as it may form a radical, may be any one selected from azo-based radical initiators, thermal initiators, and photoinitiators, and preferably, may use azoisobutyronitrile (AIBN) which does not deteriorate a polymerized copolymer without causing photocrosslinking of the repeating unit represented by Chemical Formula 5 of the copolymer, and the like.

When the initiator according to an exemplary embodiment of the present invention is included at 0.01 to 1 part by weight with respect to 100 parts by weight of the monomer mixture included, a copolymer having a weight average molecular weight in the following range may be produced, but the present invention is not limited thereto as long as the physical properties e produced copolymer are not impaired.

The copolymer according to an exemplary embodiment of the present invention may have a weight average molecular weight of 100,000 to 2,000,000 g/mol, specifically 500,000 to 2,000,000 g/mol, and more specifically 1,000,000 to 2,000,000 g/mol.

The copolymer having the weight average molecular weight may satisfy mechanical strength with the high molecular weight, may also provide excellent viscosity to coating operation, and includes a titanium-alkoxide to provide good viscosity for reacting even in providing the copolymer-titanium composite, which is thus preferred, but is not limited thereto.

A method of measuring the weight average molecular weight of the copolymer may be dissolving the copolymer in tetrahydrofuran (THF) and performing measurement under the conditions of a mobile phase solvent flow rate of 1.0 mL/min in a column heater (ALLCOLHTRB) at 40° C., using gel permeation chromatography (GPC) equipment (Waters).

In the method of producing a copolymer-titanium composite composition according to an exemplary embodiment of the present invention, the copolymer and the titanium-alkoxide may be added at a mass ratio of 1:99 to 99:1, specifically 10 to 90:10 to 10, and more specifically 30 to 70:70 to 30.

The copolymer-titanium composite composition produced at the mass ratio may have an excellent refractive index and a film produced by including the copolymer may have a thickness of 400 nm or less, and thus, the composition may be preferred, but the refractive index and the thickness of the film are adjustable depending on the mass ratio of titanium inorganic particles, and thus, the present invention is not limited thereto.

In an exemplary embodiment of the present invention, a titanium-alkoxide may be represented by Ti(OR)₄ wherein R may be C₁ to C₈ alkyl.

Specifically, R may be C₁ to C₆ alkyl, and more specifically, the titanium-alkoxide may be any one or two or more selected from titanium-methoxide, titanium-ethoxide, titanium-isopropoxide, titanium-propoxide, and titanium-isobutoxide.

Hereinafter, an organic film produced by including the copolymer composition and an organic-inorganic hybrid film produced by including the copolymer-titanium composite will be described in more detail.

An embodiment of the present invention may provide an organic film produced from the copolymer composition, or an organic-inorganic hybrid film produced by including the copolymer-titanium composite composition.

The organic film or the organic-inorganic hybrid film according to an exemplary embodiment of the present invention may be coated on a substrate by a coating method selected from spin casting, painting brushing, doctor blade, immersion method, and the like, of the copolymer composition or the copolymer-titanium composite composition.

Specifically, the organic film or the organic-inorganic hybrid film may have a smooth surface when it is produced by coating the copolymer composition or the copolymer-titanium composite composition by spin casting, but is not limited thereto.

In an exemplary embodiment of the present invention, the organic-inorganic hybrid film may be a film crosslinked by irradiating the copolymer-titanium composite composition with UVA.

In addition, the organic film produced by including the copolymer according to an exemplary embodiment may also be an organic film crosslinked by irradiating the copolymer composition with UVA.

Since the copolymer or the copolymer-titanium composite contains a benzophenone-based functional group, the copolymer composition and the copolymer-titanium composite composition may be crosslinked without including a photoinitiator or a crosslinking agent, but inclusion of the photoinitiator and the crosslinking agent is not excluded.

In an exemplary embodiment of the present invention, the film may be crosslinked by irradiating the copolymer composition or the copolymer-titanium composite composition coated on a substrate with ultraviolet rays having a wavelength of 300 to 400 nm, and more specifically, by irradiating the composition with ultraviolet rays of 350 to 400 nm.

The ultraviolet rays having a wavelength in the above range may form a radical of a benzophenone-based functional group of the copolymer or the copolymer-titanium composite, whereby the produced film may have an excellent gelation rate, which is thus preferred.

In an exemplary embodiment of the present invention, the organic-inorganic hybrid film may have a thickness of 400 nm or less, 350 nm or less, 300 nm or less, preferably 200 nm or less, 150 nm or less, more preferably 100 nm or less, 80 nm or less, 75 nm or less, or 70 nm or less, and the lower limit is not limited, may be 50 nm or less.

The thickness of the organic-inorganic hybrid film in the above range may have an adjustable thickness depending on the content of the oxygen-titanium network structure contained in the copolymer-titanium composite when the copolymer-titanium composite is included, and may be significantly thinner than a conventional inorganic film.

The organic-inorganic hybrid film according to an exemplary embodiment of the present invention may have a refractive index of 1 to 3 as measured with ISO 489.

Specifically, the organic-inorganic hybrid film may have an increased refractive index as the oxygen-titanium network structure of the included copolymer-titanium composite is increased, and may provide an organic-inorganic hybrid film having a refractive index improved by 30% or more as compared with a thin film having no oxygen-titanium network structure. The refractive index of the organic-inorganic hybrid film is not limited, but may be 1.40 or more, 1.50 or more, 1.55 or more, and more specifically 1.4 to 1.8.

That is, the organic-inorganic hybrid film may have a refractive index which may be adjusted without a thickness change rate as compared with a conventional inorganic film having a refractive index which is adjusted depending on the thickness change rate, and not only have flexibility, impact strength, and chemical resistance which are more significant than the conventional inorganic film, but also have a refractive index as good as the conventional inorganic film, and thus, may be applied to an optical film requiring a higher refractive index.

Hereinafter, the present invention will be described with reference to the examples. That is, the present invention will be understood better by the following examples, and the following examples are intended to illustrate the present invention. However, the examples of the present invention do not limit the protection scope limited by the appended claims.

### [Measurement Method of Physical Properties]

### 1. Measurement of Refractive Index and Thickness

A sample was manufactured in accordance with ISO 489 and measurement was performed. The film produced in the example was measured using a spectroscopic ellipsometer (HORIBA Scientific, UVISEL).

### Production of Dopamine Acrylamide

### Production Example 1

40.4 g of borax (105.8 mmol) and 20 g of sodium carbonate were added to 1200 mL of distilled water in a round flask (2-neck r.b.f) and sonicated for 1 hour under a vacuum environment, and nitrogen was bubbled for 2 hours to remove gas of the reactant. 10 g of dopamine hydrochloride (52.8 mmol) was added thereto under a nitrogen atmosphere, and stirring was performed for 30 minutes.

The reaction mixture was cooled to 2° C. again, and 23.6 mL of methacrylic acid anhydride (158.4 mmol) was added dropwise. When the reaction mixture was pH>9, 20 g of sodium carbonate was further added again, and stirring was performed at room temperature for 15 hours and 25 minutes. When the reaction was completed, the reaction mixture was extracted twice with a filtration device and the solvent was concentrated by evaporating at 40° C. under reduced pressure. The concentrated residue was dissolved again in the filtration device and washed twice with a hydrochloric acid solution (concentration: 0.1 N) and brine, and when the washing was completed, drying was performed with magnesium sulfate and the solvent was evaporated. The obtained crude product was separated and purified with column chromatography (dichloromethane:methanol=9:1 (v/v)) to obtain 5.8 g of white solid (yield: 53%).

### Production of Copolymer

### Example 1

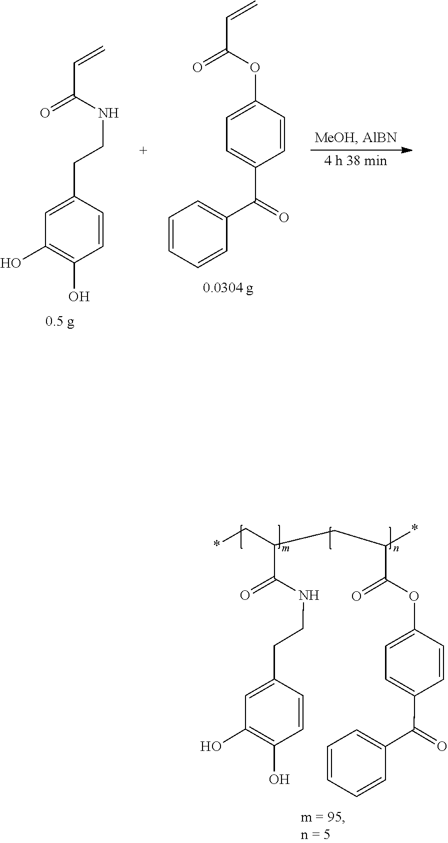

0.5 g of dopamine acrylamide (2.41 mmol) produced in Production Example 1, 0.0304 g of 4-benzoylphenyl acrylate (0.12 mmol), and 0.0039 g of azobisisobutyronitrile (AIBN) (0.0241 mmol) were added to a schlenk flask including 2 mL of methanol, and then nitrogen gas was bubbled for 10 minutes. Thereafter, the mixture was added to a silicone oil bath preheated to 70° C. and stirring was performed under a nitrogen atmosphere for 4 hours and 38 minutes. Thereafter, the reaction mixture was slowly added to 500 mL of cold diethyl ether and stirred, and the produced precipitate was obtained by filtration under reduced pressure. The obtained precipitate was washed with diethyl ether and dried in a vacuum oven at 50° C. for 24 hours to obtain a copolymer in the form of a white solid.

### Example 2

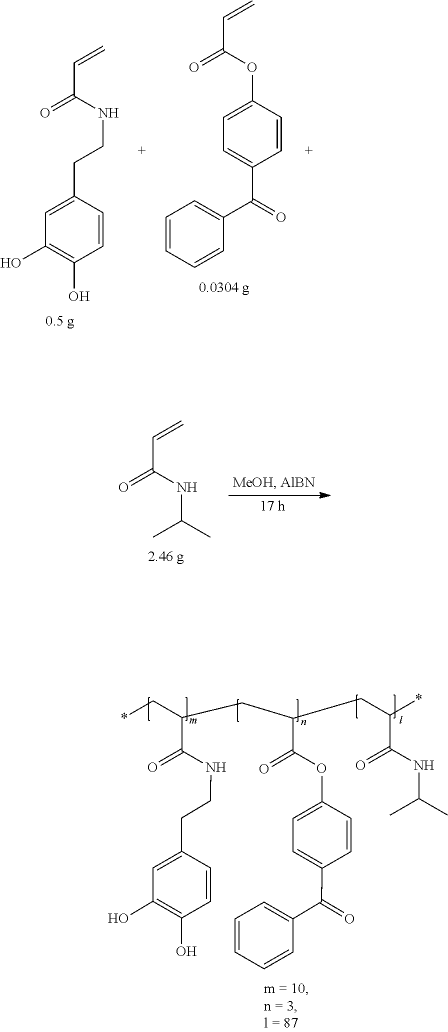

0.50 g of dopamine acrylamide (2.41 mmol) produced in Production Example 1, 0.30 g of 4-benzoylphenyl acrylate (1.21 mmol), 2.46 g of N-isopropylacrylamide (21.72 mmol), and 0.04 g of azobisisobutyronitrile (AIBN) (0.25 mmol) were added to a schlenk flask including 33 mL of methanol, and then nitrogen gas was bubbled for 10 minutes. Thereafter, the mixture was added to a silicone oil bath preheated to 70° C. and stirring was performed under a nitrogen atmosphere for 17 hours. Thereafter, the reaction mixture was slowly added to 1 L of cold diethyl ether and stirred, and the produced precipitate was obtained by filtration under reduced pressure. The obtained precipitate was washed with diethyl ether and dried in a vacuum oven at 30° C. for 24 hours to obtain a copolymer in the form of a white solid.

### Copolymer Composition and Film Produced by Including the Composition

### Examples 3 and 4

Compositions were produced with the compounds and the contents listed in the following Table 1, and films were produced using them. Specifically, the product of Example 1 was dissolved in a methanol solvent, the product of Example 2 was dissolved in a 1-propanol solvent, and the composition was coated on a silicon-water by spin-casting (2000 rpm 2/12 s). The coated silicon-wafer was further thermally dried and crosslinking was performed by irradiation with UVA (320-400 nm) to produce a film.

Thereafter, the produced film was measured by the above measurement method and the results are shown in the following Table 2.

### Copolymer-Titanium Composite Composition and Film Produced by Including the Composition

### Examples 5 to 10

Each compound added was used with the kind and the content listed in the following Table 1. Hydrochloric acid was added dropwise to a flask including the copolymer at the content shown in the following Table 1 under a room temperature environment and stirring was performed for 30 minutes or more. Thereafter, titanium inorganic particles were added dropwise and stirring was slowly performed for 30 minutes to produce a copolymer-titanium composite composition. Thereafter, the composition was coated on a silicon-wafer by spin-casting (2000 rpm 2/12 s). The coated silicon-wafer was further thermally dried and crosslinking was performed by irradiation with UVA (320-400 nm) to produce a film.

Thereafter, the produced film was measured by the above measurement method and the results are shown in the following Table 2.

### Comparative Example 1

Each compound added was used with the kind and the content listed in the following Table 1. Hydrochloric acid was added dropwise in a room temperature environment and stirring was performed for 30 minutes or more. Titanium inorganic particles were added dropwise and stirring was slowly performed for 30 minutes. Thereafter, the composition was coated on a silicon-wafer by spin-casting (2000 rpm 2/12 s). The coated silicon-wafer was further thermally dried to produce a film including only an inorganic material.

Thereafter, the produced film was measured by the above measurement method and the results are shown in the following Table 2.

TABLE 1

| | | | | | Titanium inorganic | |
|---|---|---|---|---|---|---|
| | | | | | particles | |
| | Copolymer | | | Hydrochloric | | Added |
| | Type | Content | Solvent | acid (mL) | Type | amount |
| Example 3 | Example 1 | 0.1 g | 6 mL of | — | x | x |
| | | | methanol | | | |
| Example 4 | Example 2 | 0.2 g | 20 mL of | — | x | x |
| | | | 1-propanol | | | |
| Example 5 | Example 1 | 0.1 g | 6 mL of | 0.01 | Ti- | 1.00 g, |
| | | | methanol | | butoxide | 2.93 mmol |
| Example 6 | Example 1 | 0.1 g | 6 mL of | 0.01 | Ti- | 3.99 g, |
| | | | methanol | | butoxide | 11.73 mmol |
| Example 7 | Example 2 | 0.2 g | 20 mL of | 0.02 | Ti- | 0.08 g, |
| | | | 1-propanol | | propoxide | 0.28 mmol |
| Example 8 | Example 2 | 0.2 g | 20 mL of | 0.02 | Ti- | 0.31 g, |
| | | | 1-propanol | | propoxide | 1.07 mmol |
| Example 9 | Example 2 | 0.2 g | 20 mL of | 0.02 | Ti- | 0.71 g, |
| | | | 1-propanol | | propoxide | 2.50 mmol |
| Example 10 | Example 2 | 0.2 g | 20 mL of | 0.02 | Ti- | 1.66 g, |
| | | | 1-propanol | | propoxide | 5.84 mmol |
| Comparative | x | x | 15 mL of | 0.02 | Ti- | 6.79 g, |
| Example 1 | | | butanol | | butoxide | 19.95 mmol |

TABLE 2

| | Thickness | Refractive |
|---|---|---|
| | (nm) | index |
| Example 3 | 70 | 1.571 |
| Example 4 | 59 | 1.460 |
| Example 5 | 230 | 1.705 |
| Example 6 | 330 | 1.766 |
| Example 7 | 74 | 1.452 |
| Example 8 | 80 | 1.612 |
| Example 9 | 91 | 1.660 |
| Example 10 | 143 | 1.710 |
| Comparative | 370 | 1.776 |
| Example 1 | | |

As shown in Table 2, the copolymer of the present invention may produce a film having an excellent refractive index. In addition, the refractive index may be adjusted depending on the content of the titanium inorganic particles.

Examples 3 and 4 were films produced using the copolymer compositions. As shown in Table 2, the thickness of Example 3 was 70 nm and the thickness of Example 4 was 59 nm. The refractive indexes of Examples 3 and 4 were similar to that of a common polymer-based film. In addition, the refractive index of Example 3 was higher than that of Example 4. This is a phenomenon shown due to the distribution of benzene of Example 1 which was higher than that of Example 2.

Comparing Examples 3, 5, and 6, it was confirmed that as the content of the titanium inorganic particles was increased, the refractive index was increased.

In addition, comparing Example 4 with Examples 7 to 10, it was confirmed that as the content of the titanium inorganic particles was increased, the refractive index was increased.

Therefore, it was confirmed that the copolymer of the present invention has an excellent refractive index and the titanium inorganic particles may react with the repeating unit of the dopamine-based acrylamide of the copolymer. The copolymer-titanium composite may be produced by the reaction, and the copolymer-titanium composite may have a refractive index which is adjustable depending on the added amount of the titanium inorganic particles.

As a result, the copolymer-titanium composite of the present invention has flexibility of the polymer-based flexibility-adjustable film and may produce a film having an excellent refractive index. In addition, the copolymer-titanium composite may have an adjustable refractive index, may be used in materials requiring various refractive indexes, and may be produced by a simple process in adjusting the refractive index.

The present invention described above is only an example, and it may be well understood by a person with ordinary knowledge in the art to which the present invention pertains that various modification and equivalent other examples are 36/36 Substitute Specification-Clean possible therefrom. Therefore, it may be well understood that the present invention is not limited only to the form mentioned in the above detailed description. Accordingly, the true technical protection scope of the present invention must be determined by the spirit of the appended claims.

Therefore, the spirit of the present invention should not be limited to the above-described exemplary embodiments, and the following claims as well as all modifications equal or equivalent to the claims are intended to fall within the scope and spirit of the invention.

1. A copolymer-titanium composite comprising repeating units represented by the following Chemical Formulae 1 and 2: 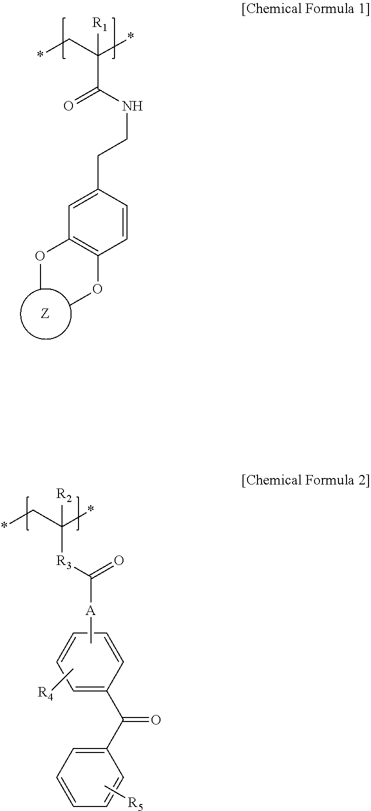
wherein
R₁, R₂, R₄, and R₅ are independently of one another hydrogen, a halogen, or a C₁ to C₄ alkyl group, R₃ is a single bond or C₁ to C₃ alkylene, A is —O— or —NH—, and Z is an oxygen-titanium network structure.

2. The copolymer-titanium composite of claim 1, wherein in Chemical Formulae 1 and 2, R₁ and R₂ are independently of each other hydrogen or C₁ to C₃ alkyl, R₄ and R₅ are independently of each other hydrogen or a halogen, R₃ is a single bond or methylene, A is —O— or —NH—, and Z is an oxygen-titanium network structure.

3. The copolymer-titanium composite of claim 1, wherein the copolymer-titanium composite has a mole ratio between Chemical Formula 1 and Chemical Formula 2 of 95:5 to 80:20.

4. The copolymer-titanium composite of claim 1, wherein the copolymer-titanium composite further includes a repeating unit represented by the following Chemical Formula 3: 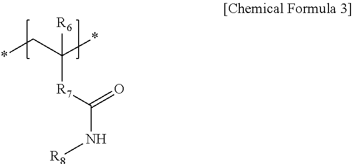
wherein
R₆ is hydrogen, a halogen, or C₁ to C₄ alkyl, R₇ is a single bond or C₁ to C₃ alkylene, and R₈ is C₁ to C₁₀ alkyl or a halogen.

5. The copolymer-titanium composite of claim 4, wherein in Chemical Formula 3, R₆ is independently of each other hydrogen or methyl, R₇ is a single bond or methylene, and R₈ is C₂ to C₈ alkyl.

6. The copolymer-titanium composite of claim 4, wherein the copolymer-titanium composite has a mole fraction of Chemical Formulae 1 to 3 of m, n, and 1 in which m, n, and l are rational numbers satisfying 0.08≤m≤0.15, 0.02≤n≤0.05, 0.8≤l≤0.9, and m+n+l=1.

7. A copolymer-titanium composite composition comprising the copolymer-titanium composite of claim 1.

8. A method of producing a copolymer-titanium composite composition, the method comprising:
adding a copolymer including repeating units of Chemical Formulae 4 and 5 to a solvent including an acid catalyst to produce a copolymer solution; and
adding a titanium-alkoxide to the copolymer solution to produce a copolymer-titanium composite composition: 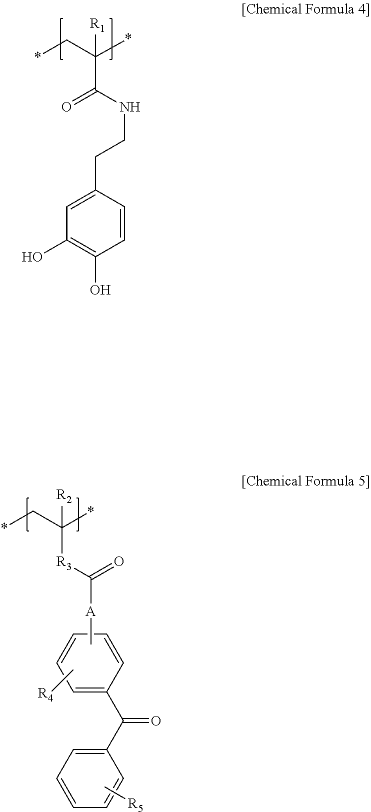
wherein
R₁, R₂, R₄, and R₅ are independently of one another hydrogen, a halogen, or a C₁ to C₄ alkyl group, R₃ is a single bond or C₁ to C₃ alkylene, and A is —O— or —NH—.

9. The method of producing a copolymer-titanium composite composition of claim 8, wherein the copolymer further includes a repeating unit represented by the following Chemical Formula 6: 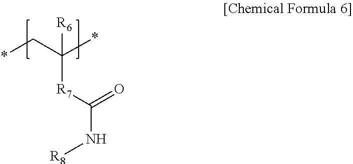
wherein
R₆ is hydrogen, a halogen, or C₁ to C₄ alkyl, R₇ is a single bond or C₁ to C₃ alkylene, and R₈ is C₁ to C₁₀ alkyl or a halogen.

10. The method of producing a copolymer-titanium composite composition of claim 8, wherein the solvent is any one or two or more selected from ether-based solvents, ketone-based solvents, amide-based solvents, alcohol-based solvents, sulfone-based solvents, and aromatic hydrocarbon-based solvents.

11. The method of producing a copolymer-titanium composite composition of claim 8, wherein the copolymer and the titanium-alkoxide are added at a mass ratio of 1:99 to 99:1.

12. The method of producing a copolymer-titanium composite composition of claim 8, wherein the titanium-alkoxide is Ti(OR)₄, in which R is C₁ to C₈ alkyl.

13. An organic-inorganic hybrid film which is produced with the copolymer-titanium composite composition of claim 7 and has a refractive index of 1 to 3.

14. A copolymer comprising repeating units represented by the following Chemical Formulae 4 and 5: 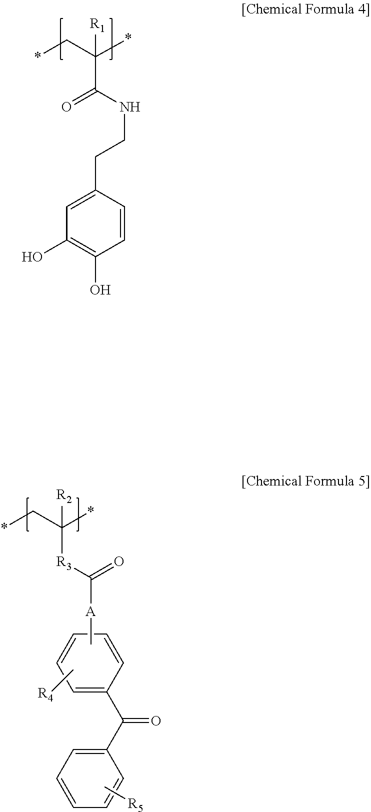
wherein
R₁, R₂, R₄, and R₅ are independently of one another hydrogen, a halogen, or a C₁ to C₄ alkyl group, R₃ is a single bond or C₁ to C₃ alkylene, and A is —O— or —NH—.

15. The copolymer of claim 14, further comprising: a repeating unit represented by the following Chemical Formula 6:

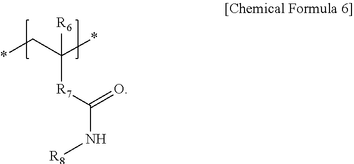

16. A copolymer composition comprising the copolymer of claim 14 and a solvent.

17. A copolymer composition comprising the copolymer of claim 15 and a solvent.
